(19) United States
(12) Patent Application Publication
(10) Pub. No.: US 2007/0136356 A1
(43) Pub. Date: Jun. 14, 2007

(54) Mechanism for drivers to create alternate namespaces

(75) Inventors: Frederick J. Smith, Redmond, WA (US); Jeff L. Havens, Issaquah, WA (US); Madhusudhan Talluri, Bellevue, WA (US); Yousef A. Khalidi, Bellevue, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/301,072

(22) Filed: Dec. 12, 2005

(51) Int. Cl. G06F 7/00

(52) U.S. Cl. 707/102

(57) ABSTRACT

An intra-operating system isolation mechanism called a silo provides for the grouping of processes running on a single computer using a single instance of the operating system. The operating system divides the system into multiple side-by-side and/or nested environments enabling the partitioning and controlled sharing of resources and providing an isolated application environment in which applications can run. More specifically, a system environment may be divided into an infrastructure silo and one or more server silos. Each server silo is provided with its own copy of the device driver name space. Each device is associated with a system device object accessed via a system device functional interface and with a server silo-specific device object accessed via a control device interface. The infrastructure silo populates the silo-specific device name space with the control device interface. The server silo uses the control device interface to create new device object(s) as needed.

### CROSS-REFERENCE TO RELATED CASES

This application is related in subject matter to U.S. patent application Ser. No. ______, Attorney Docket Number MSFT-5290/314219.01 entitled “Using Virtual Hierarchies to Build Alternative Namespaces” filed herewith, U.S. patent application Ser. No. ______, Attorney Docket Number MSFT-5295/314223.01 entitled “Use of Rules Engine to Build Namespaces” filed herewith, U.S. patent application Ser. No. ______, Attorney Docket Number MSFT-5294/314222.01 entitled “OS Mini-Boot for Running Multiple Environments” filed herewith, and U.S. patent application Ser. No. ______, Attorney Docket Number MSFT-5465/31422.01 entitled “Building Alternative Views Of Name Spaces” filed herewith.

### BACKGROUND

When a single computer is used to run multiple workloads, a balance should be struck between isolation of applications and the cost of using and administering the application-isolating system. Applications should ideally be isolated from each other so that the workload of one application does not interfere with the operation or use of resources of another application. On the other hand, the system should be flexible and manageable to reduce the cost of using and administering the system. Ideally, the system should be able to selectively share resources while maintaining application isolation. Typically, however, all processes running under the same user account have the same view of system resources. The lack of isolation of the applications running on a particular computer contributes to application fragility, application incompatibility, security problems and the inability to run conflicting applications on the same machine.

a number of different solutions have been proposed which address one or more aspects of the problems discussed above. One way to isolate applications running on the same machine is to run the applications on different “virtual machines”. A virtual machine (VM) enables multiple instances of an operating system (OS) to run concurrently on a single machine. A VM is a logical instance of a physical machine, that is, a virtual machine provides to the operating system software an abstraction of a machine at the level of the hardware: that is, at the level of the central processing unit (CPU), controller, memory, and so on. Each logical instance has its own operating system instance with its own security context and its own isolated hardware resources so that each operating system instance appears to the user or observer to be an independent machine. VMs are typically implemented to maximize hardware utilization. A VM provides isolation at the level of the machine but within the virtual machine, no provisions for isolating applications running on the same VM are provided for by known VM implementations.

Other known proposed solutions to aspects of the problems described above include Sun Microsystem's Solaris Zones, jails for UNIX BSD and Linux, the VServers project for Linux, SWSoft's Virtuozzo, web hosting solutions from Ensim and Sphera, and software available from PolicyMaker, and Softricity.

Another approach that addresses aspects of application isolation is hardware partitioning. A multi-processor machine is divided into sub-machines, each sub-machine booting an independent copy of the OS. Hardware partitioning typically only provides constrained resource allocation mechanisms (e.g., per-CPU allocation), does not enable input/output (IO) sharing and is typically limited to high-end servers.

Hence, in many systems, limited points of containment in the system exist at the operating system process level and at the machine boundary of the operating system itself, but in between these levels, security controls such as Access Control Lists (ACLs) and privileges associated with the identity of the user running the application are used to control process access to resources. There are a number of drawbacks associated with this model. Because access to system resources is associated with the identity of the user running the application rather than with the application itself, the application may have access to more resources than the application needs. Because multiple applications can modify the same files, incompatibility between applications can result. There are a number of other well-known problems as well.

There is no known easy and robust solution using known mechanisms that enables applications to be isolated while still allowing controlled sharing of resources. It would be helpful if there were a mechanism that allowed an application, process, group of applications or group of processes running on a single machine to be isolated using a single operating system instance while enabling controlled sharing of resources.

### SUMMARY

An intra-operating system isolation/containment mechanism, called herein a silo provides for the grouping and isolation of processes running on a single computer using a single instance of the operating system. A single instance of the operating system enables the partitioning and controlled sharing of resources by providing a view of a system name space to processes executing within a silo. A system may include a number of silos (i.e., one infrastructure silo and one or more server silos) and a number of system name spaces. An infrastructure silo is the root or top-level silo. The entire system name space is visible to the infrastructure silo. Each server silo may be provided with its own view of a system name space so that only a subset of the system name space is visible to the server silo. Applications may be installed in the server silo. Thus, a set of related and/or non-conflicting applications may be installed in one server silo and another set of conflicting applications may be installed in a second server silo. Because each server silo “sees” a different subset of the system name space, and may have its own set of files, applications that would otherwise conflict with each other, can run simultaneously on the same machine without conflict. Thus multiple server silos can be used to isolate or separate different sets of applications so that a number of conflicting applications can be run on the same computer without experiencing the problems which typically ensue from running conflicting applications on the same computer. This result is accomplished by providing a silo-specific view of the system name space(s) for each server silo. In addition, this result can be obtained without modifying program code because the server silo's name space is renamed or remapped so that references are unchanged. For example, an application running in a silo that accesses a file (e.g., in \WINDOWS) is mapped to access the silo-specific file (e.g., \SILO\<SILONAME>\WINDOWS.

Each server silo may be provided with its own copy of the device name space. Each device may have two types of interfaces, a functional interface and a control interface. The control interface may be used to create (and destroy) additional instances of the functional interface. The infrastructure silo may populate the silo-specific device name space with the control device interface. The server silo may use the control device interface to create new device object(s) to implement/export the functional interface as needed in the normal control flow, from within the silo and thus within the context of the silo, and having access only to a silo-specific view of the system object name space and registry. Because the device object is created by the silo in the silo context, major changes to the kernel code are unnecessary. Alternatively, the infrastructure silo may create new functional interfaces and populate the silo-specific name spaces with the new functional interfaces.

### BRIEF DESCRIPTION OF THE DRAWINGS

In the Drawings:

FIG. 1 is a block diagram illustrating an exemplary computing environment in which aspects of the invention may be implemented;

FIG. 2 is a block diagram of a system for creating and maintaining separate device name spaces in accordance with some embodiments of the invention;

FIG. 3 is a flow chart of a process for creating and maintaining separate device name spaces in accordance with some embodiments of the invention.

### DETAILED DESCRIPTION

Overview

It is advantageous at times to be able to run multiple environments on the same computer. For example, a business enterprise may have a number of servers that each run a service that the enterprise would like to consolidate onto a single machine so that there are not so many machines to manage. For example, the Human Resources department, the purchasing department and the payroll department may each have an email server running on a separate machine that they would like to run on the same machine. Similarly, it may be desirable to consolidate a numbers of separate servers onto a single machine that performs the functions of all of the separate servers (e.g., to consolidate a separate email server, web server, file server and printer server onto a single server that performs email, web, file and print services.) A business enterprise may have a web server for hosting web sites or for providing web services. In each case, the applications running in one environment should be kept separate from the others. In other words, the success of the venture may depend on keeping separate environments separate. Typically, however, this is not an easy task. When two server applications are placed on the same machine, frequently name conflicts arise, one application overwrites another's application's files, version problems surface and so on.

An effective solution for the above problem statement may fulfill the following requirements: applications should be isolated; applications should not need to be modified in order to run within the application environment; a single kernel or operating system should run on the system; and administrative tasks should be shared. Isolation of applications implies that multiple instances of the same application should be able to run at the same time and/or on the same machine; applications should be able to be added to or removed from one application environment without affecting any other environment on the system; and different versions of the same application should be able to run at the same time. That applications should not need to be modified in order to run within the application environment implies that applications should be able to use the same names and references regardless of where they run (inside or outside the isolated environment). Running a single kernel or OS implies efficiencies of operation because only one instance of the OS has to be maintained. For example, all the hardware management and drivers only need to be set up once. Administrative tasks should be shared so that routine administrative tasks for the application environment could be delegated to an application environment administrator. The application environment administrator should be able to affect only his own environment.

One solution to the above provides a mechanism for application isolation by creating one or more sandboxed silos for running existing (unmodified) applications by partitioning the system into an infrastructure silo and one or more server silos. Each silo has one or more silo-specific name spaces that provide a view of the system name space. One such silo-specific name space may be the device name space.

The term “driver” as used here, may refer to any software components in the kernel of an operating system. One type of driver is a hardware device driver. A hardware device driver is software that enables another program, typically an operating system, to interact with a hardware device. A hardware device driver provides the operating system with information about how to control and communicate with a particular piece of hardware. Every model of hardware is different and newer models of the same piece of hardware also are often controlled differently. To make the task of keeping the operating system current with hardware changes easier, operating systems specify how each type of device should be controlled. The device driver translates these OS-mandated function calls into device-specific calls.

When a server silo is booted, it shares the same kernel modules used by the infrastructure silo. Because there are usually well-known names or identifiers in the object name space, a conflict arises between the infrastructure silo and the server silo. In addition, it is difficult to specify at boot time which server silos need which devices. Thus it would be preferable to allow the device drivers to be loaded on demand by the silo itself during the normal control flow. To address these issues, the system device object provides the normal functional interface for the device and a second device object provides a control interface for the same device. The infrastructure silo populates the silo's device name space with the control interface. The silo uses the control interface to create new device object(s) for the creating silo only, without affecting the system name space or other silos' name spaces.

Named pipes are one example of where such a mechanism would be advantageous. Named pipes allow unrelated processes to communicate with each other whereas the normal (un-named) kind can only be used by processes which are parent and child or siblings. Thus, a named pipe is a method for passing information from one computer process to other processes using a pipe or message holding place that is given a specific name. Unlike a regular pipe, a named pipe can be used by processes that do not have to share a common process origin. Furthermore, the message sent to the named pipe can be read by any authorized process that knows the name of the named pipe. Thus uncontrolled creation of named pipes are likely to compromise the infrastructure device name space because named pipes are associated with a well-known name or identifier that existing software relies on. Thus running multiple copies of the software on a single computer is likely to result in multiple processes accessing the same name in a name space, causing conflicts. One solution to the problem is to create a new control device for the named pipe with a limited set of operations that the silo can use to create new name space for the named pipes for the silo without affecting the system name space or other silos' name spaces. Details are provided below.

Exemplary Computing Environment

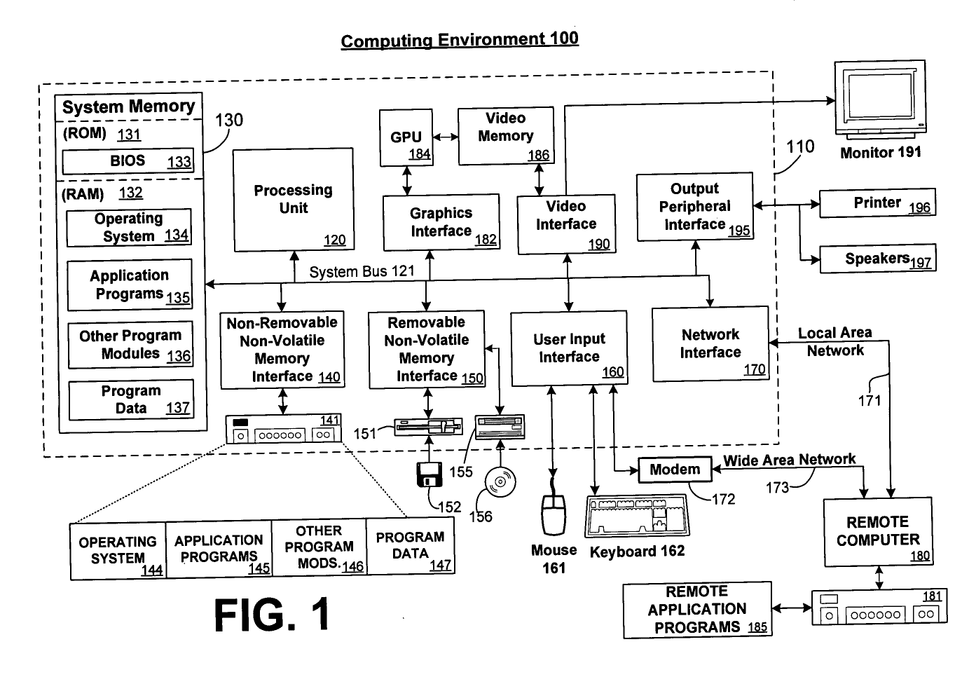

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

Using Device Drivers to Create Multiple Application Environments

In some embodiments of the invention, multiple application environments can be created and maintained by creating a root or top-level (infrastructure) silo and one or more isolated application environments (server silos). Each server silo is associated with a server silo-specific view of a global or system name space such as a file system, registry, system object, process identifier, GUID, LUID, network or other name space. All or some parts of private or silo-specific name spaces may be populated, enabling controlled sharing of some resources, while restricting access of the silo to other resources, thereby facilitating resource management.

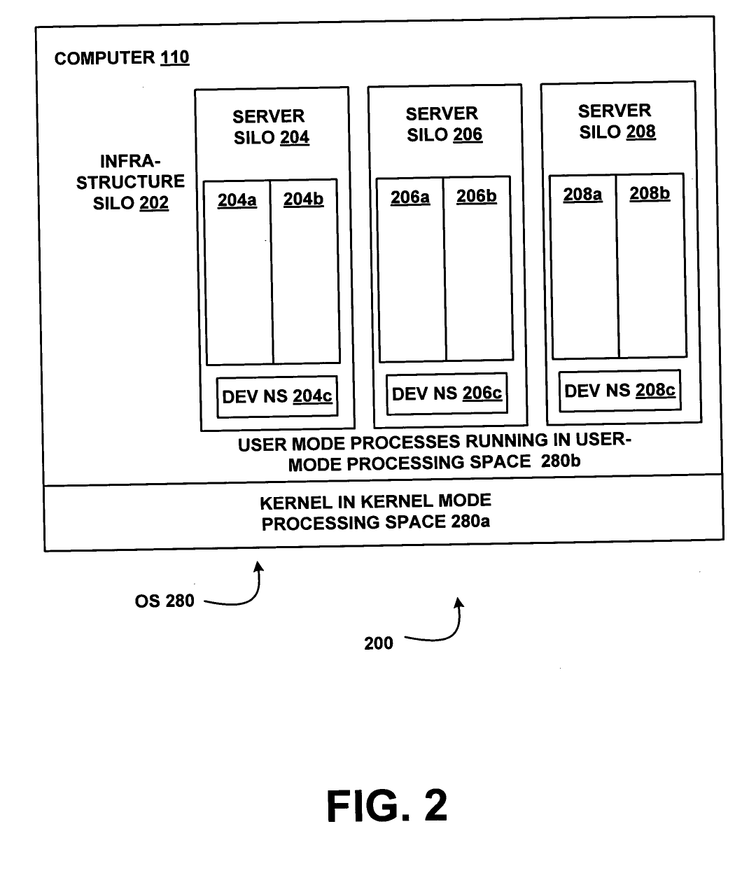

FIG. 2 is a block diagram illustrating a system for creating and maintaining separate environments in accordance with some embodiments of the invention. System 200 may reside on a computer such as the one described above with respect to FIG. 1. System 200 may include one or more partitions (not shown). A drive letter abstraction may be provided at the user level to distinguish one partition from another. For example, the path C:\WINDOWS\ may represent a directory WINDOWS on the partition represented by the letter C. Each drive letter or partition may be associated with a hierarchical data structure. Each hierarchy has a root which represents the first or top-most node in the hierarchy. It is the starting point from which all the nodes in the hierarchy originate. As each device may be partitioned into multiple partitions, multiple roots may be associated with a single device. (For example, a user's physical hard disk may be partitioned into multiple logical “disks”, each of which have their own “drive letter” and their own root.) A single instance of the operating system images serves all the partitions of the computer in some embodiments of the invention.

Within each partition, system 200 may include one or more isolated application environments. In some embodiments of the invention, the isolated application environments are server silos (e.g., server silo 204, server silo 206 and server silo 208) and infrastructure silo 202 represents a root or top-level silo. Although FIG. 2 illustrates an infrastructure silo and three server silos, it will be appreciated that the invention as contemplated is not so limited. Any number of server silos (from none to any suitable number) may be created. Infrastructure silo 202 may be associated with one or more system or global name spaces, represented in FIG. 2 by system name space 210. Various types of system name spaces including hierarchical name spaces, number spaces, number/name spaces, and network compartments may exist. Each server silo may have a subset view of these system name spaces.

System 200 may also include an operating system 280. The operating system 280 may include one or more operating system components including but not limited to an operating system kernel and an object manager. In some embodiments of the invention, the object manager is a component of the operating system kernel. In some embodiments of the invention, some portions of the operating system operate in kernel mode 280a while others operate in user mode 280b. A mode is a logical and systematic separation of services, functions, and components. Each mode has specific abilities and code components that it alone uses to provide the functions and perform the tasks delegated to it.

Kernel 280a in some embodiments of the invention creates an infrastructure silo and one or more server silos. In some embodiments of the invention, the kernel creates a device object for a device having a set of operations for the device. The kernel may also create a second device object for the device having a second set of operations for the device. The second set of operations may be a subset of the first set of operations for the device or may be different from the first set of operations. That is, the device provides its normal function interface through the first device object. A second control interface is provided through the second device object. Independent device name spaces are provided to each silo. The infrastructure silo populates the silo's name space with the control interface. The silo then uses the control interface to create new device objects for the silo. Separating the control device from the functional device allows the control device to be shared with the silo, giving the silo the ability to create new devices without affecting the infrastructure name space or the other server silos' name spaces. The silo is able to create devices as needed in normal processing and executes the code to create the device within the context of the silo.

In some operating systems including Microsoft WINDOWS, some drivers are name space providers (e.g., in WINDOWS the name of the name space used for device drivers is \Device\<DeviceName>\ in the system object name space. For the infrastructure to access the silo's functional interface, it would use an object name such as, \silo\<siloname>\Device\<DeviceName>. The infrastructure silo creates the control and populates the silo name space with it. The control device may be given a name such as \Device\<ControlDeviceName>. When the silo name space is populated, the control interface is accessed by the silo using the name \Device\Control\<DeviceName>.

System 200 may include one or more side-by-side silos 204, 206, 208, etc. in each partition or associated with each drive letter. Each silo may be associated with its own view of global name spaces including but not limited to those listed above. Each silo, however, shares a single operating system instance with all the silos on the system. For example, in FIG. 2, infrastructure silo 202 and server silos 204, 206 and 208 may each be associated with their own views but are all served by the same kernel operating system instance (kernel 280a). Each server silo may include one or more sessions. For example, server silo 204 includes two sessions, session 204a and 204b, server silo 206 includes two sessions, session 206a and 206b and server silo 208 includes two sessions, session 208a and 208b. It will be understood however, that server silos are not limited to two sessions. Any number of sessions may be initiated and may run concurrently in a server silo. In some embodiments one session (e.g., 204a) runs system and applications and the other session or session (e.g., 204b, etc.) are reserved for remote interactive logins.

A server silo may be administered at least in part by a server silo administrator. For example, the server silo administrator may be able to configure applications running in his silo, and to configure network settings, set firewall rules, specify users who are allowed access to the server silo and so on. A server silo administrator cannot affect any silo except his own. Furthermore, at least some system administration tasks cannot be performed by the server silo administrator.

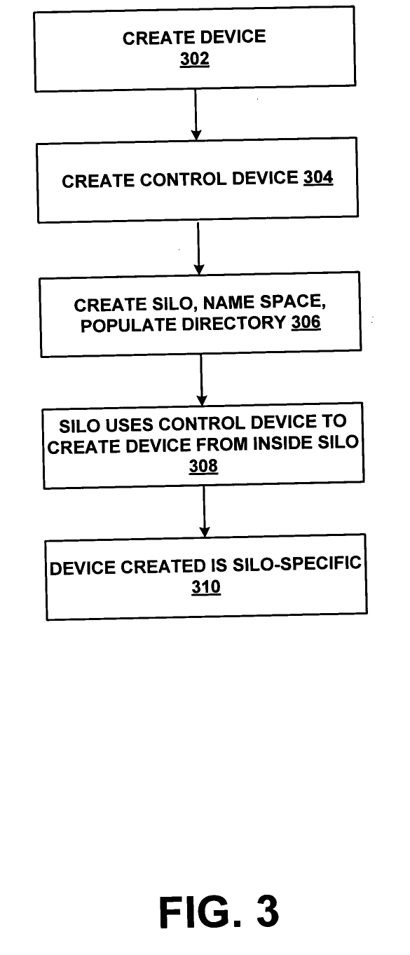

FIG. 3 is a flow chart of a process for creating multiple application environments using a device driver in accordance with some embodiments of the invention (e.g., such as for the embodiments illustrated in FIG. 2.) FIG. 3 illustrates the use of a device driver to create a silo-specific driver name space, in accordance with some embodiments of the invention. At 302 the device is created within the kernel. In some embodiments of the invention, such a device is created by the kernel of an operating system, wherein the device is expressed as a device object associated with a device interface. In some embodiments of the invention, operations associated with the device object include create, delete, and query/enumerate for the control interface and a well-known standard set of operations on the functional interface. The first device object may be used by a process running outside of a server silo to create a device.

At 304 a second object is created for the device. The second object created for the device may be associated with operations including create and delete and may be operated upon via a second interface referred to as a control interface. The control interface may enable operations which are a subset of the operations for the first interface. Thus, the control interface may be used by a process running within a server silo to create a silo-specific device, while the first interface may be used by a processes running outside a server silo to create a non-silo-specific device. At 306 the kernel may generate a silo-specific device name space. The silo-specific name space may comprise a silo-specific branch of a system object name space. All or a portion of the silo-specific device name space may be populated by the kernel. In some embodiments of the invention, the kernel populates the silo-specific name space with the second device object. At 308, the silo uses the second device object to create a new device. Because the silo is creating the new device, the device is created within the context of the silo. Any device created from within the silo will be restricted to the silo-specific portion of the system object name space, so that any device created by the silo will not affect the infrastructure silo or any other server silos on the computer.

For example, suppose a named pipe device is to be created within the silo. At 302, the kernel may create a first object for device named pipe (\Device\NamedPipe). At 304, the kernel may create a second object for the named pipe device (\Device\ControlNamedPipe). The first object may have a functional interface, interface 1. The second object may have a control interface, interface 2. At 306, The infrastructure silo creates the silo device name space at \Silo\<Siloname>\Device and populates it with the control device at \Silo\<Siloname>\Device\Control\NamedPipe. At 308, the Silo uses the control device at \Device\Control\NamedPipe to create the silo-specific device \Device\NamedPipe in the silo namespace. The effect this has is that named pipes created within a silo using names such as \Device\NamedPipe\<pipename> do not conflict with similar names other silos or the infrastructure may use.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A system for creating isolated application environments on a computer comprising:
an operating system kernel that is adapted to:
creating an infrastructure silo and at least one of a plurality of server silos comprising isolated application environments on the computer by creating for a device a first device object having a first device interface and by creating for the device a second device object having a second device interface;
populating a silo-specific device name space with the second device object, the second device object used for creating within the at least one server silo by the at least one server silo a silo-specific device using the second device interface.

2. The system of claim 1, wherein the operating system kernel is further adapted to creating the silo-specific device name space for the at least one server silo, the silo-specific device name space providing a view restricting resources available to each server silo, the view comprising links to a subset of a system device name space.

3. The system of claim 1, wherein the device comprises a named pipe.

4. The system of claim 1, wherein the second device interface enables a create or a delete operation to be performed on the silo-specific device.

5. The system of claim 1, wherein the operating system kernel prohibits the at least one server silo from creating a device using the first device interface.

6. The system of claim 1, wherein the server silo-specific device name space is a silo-specific system objects name space.

7. A method for creating isolated application environments on a single computer using a driver comprising:
creating a first device object associated with a first device interface for a device and creating a second device object associated with a second device interface for the device:
creating a server silo, the server silo comprising an isolated application environment for running applications; and
generating a server silo-specific name space for the server silo, the server-silo specific name space restricting access to a set of resources by providing a view of a subset of a set of system resources.

8. The method of claim 7, further comprising:
populating at least a first portion of the server silo-specific device name space with the second device object.

9. The method of claim 7, further comprising:
creating a device from within the server silo, the device stored in the server silo-specific name space.

10. The method of claim 7, wherein the device is a name pipe.

11. A computer-readable medium comprising computer-executable instructions for:
creating a first device object associated with a first device interface for a device; and
creating a second device object associated with a second device interface for the device.

12. The computer-readable medium of claim 11, comprising further computer-executable instructions for:
creating a server silo, the server silo comprising an isolated application environment for running applications on a single computer.

13. The computer-readable medium of claim 11, comprising further computer-executable instructions for:
generating a server silo-specific name space for the server silo, the server-silo specific name space restricting access to a set of resources by providing a view of a subset of a set of system resources.

14. The computer-readable medium of claim 11, comprising further computer-executable instructions for:
populating at least a first portion of the server silo-specific device name space with the second device object.

15. The computer-readable medium of claim 11, comprising further computer-executable instructions for:
creating a device from within the server silo, the device stored in the server silo-specific name space.

16. The computer-readable medium of claim 11, comprising further computer-executable instructions for:
creating a named pipe device.
